(19) United States
(12) Patent Application Publication
(10) Pub. No.: US 2011/0017905 A1
(43) Pub. Date: Jan. 27, 2011

(54) MICROFLUIDIC DEVICE, MICROFLUIDIC SYSTEM INCLUDING THE SAME, AND METHOD FOR DETECTING REFERENCE ANGLE OF THE MICROFLUIDIC DEVICE

(75) Inventor: Yeong Bae YEO, Daegu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/722,597

(22) Filed: Mar. 12, 2010

(30) Foreign Application Priority Data
Jul. 27, 2009 (KR) 10-2009-0068278

(51) Int. Cl. G01D 5/34; G01B 11/26

(52) U.S. Cl. 250/231.14; 356/138

(57) ABSTRACT

A microfluidic device includes a platform having a disc shape, a chamber formed on the platform, and a home position mark formed on the platform. The at least one chamber and the home position mark are arranged at a same distance from a center of the platform. The home position mark has a light transmittance which is different from a light transmittance of the at least one chamber. A microfluidic system includes a light emitting part which emits light; a light receiving part arranged to receive the light emitted by the light emitting part; the microfluidic device arranged between the light emitting part and the light receiving part; an operating part which rotates the microfluidic device; and a control part which compares an intensity of light incident upon the light receiving part with a with a reference value to detect a reference angle of the microfluidic device.

### CROSS-REFERENCE TO RELATED APPLICATION

This application claims priority from Korean Patent Application No. 10-2009-0068278 filed on Jul. 27, 2009, the disclosure of which is incorporated herein in its entirety by reference.

### BACKGROUND

1. Field

One or more embodiments relate to a microfluidic device, a microfluidic system including the device, and a method for detecting a reference angle of the device.

2. Description of the Related Art

A biochip is a collection of microfluidic structures arranged on a small chip-shaped substrate that is utilized to perform tests including biochemical reactions. A lab-on-a-chip (LOC) is a biochip that it utilized to perform processes and manipulations of several steps on a single chip. The microfluidic structures may include a chamber accommodating a fluid, a channel through which the fluid flows, a valve adjusting the flow of the fluid, and a functional unit receiving the fluid and performing a certain function.

Operational pressure is required to transport a fluid in the microfluidic structures. The operational pressure may be capillary pressure or pressure provided by a separate pump. Microfluidic devices in which the operational pressure is provided by centrifugal force have been suggested. The microfluidic devices include microfluidic structures arranged on a disc-shaped platform in order to use centrifugal force. These devices are called lab compact disc (CD), lab-on-a-CD, or lab-on-a-disc.

A microfluidic device utilizing centrifugal force may include a chamber in which the reaction of a sample is performed for a specific purpose, i.e., a cholesterol test or a liver function test. A corresponding detector may be used to detect a result of the reaction. In order to detect the result of the reaction via the detector, a position of the chamber arranged on the disc-shaped platform, and a position of the functional units should be precisely monitored.

For this purpose, there is utilized a method which includes detecting a home position, which is indicated by a metallic piece attached on the platform, with a light detector, and observing the position of the functional units and the chamber, referring to the home position as the origin. In addition to the detector which detects the reaction of a sample, a light source, a light detector, and related electric circuits for observing the home position are additionally required for this method.

### SUMMARY

One or more embodiments include a microfluidic device detecting a home position without a light source and a light detector, a microfluidic system including the device, and a method for detecting a reference angle of the device.

According to an aspect of an embodiment, there is provided a microfluidic device including a platform having a disc shape; at least one chamber formed on the platform; and a home position mark formed on the platform, wherein the at least one chamber and the home position mark are arranged at a same distance from a center of the platform, and wherein the home position mark has a light transmittance which is different from a light transmittance of the at least one chamber.

According to an aspect of an embodiment, there is provided a microfluidic system including a light emitting part which emits light; a light receiving part which receives the light emitted by the light emitting part; a microfluidic device including a platform which has a disc shape and is interposed between the light emitting part and the light receiving part, at least one chamber formed on the platform, and a home position mark formed on the platform; an operating part which rotates the microfluidic device; and a control part which compares an intensity of light incident upon the light receiving part with a reference value to detect a reference angle of the microfluidic device, wherein the at least one chamber and the home position mark are arranged at a same distance from a center of the platform, and wherein the home position mark has a light transmittance which is different from a light transmittance of the at least one chamber.

According to an aspect of an embodiment, there is provided a method for detecting a reference angle of a microfluidic device which includes a platform having a disc shape, at least one chamber formed on the platform, and a home position mark formed on the platform, the method including radiating light upon on the at least one chamber and the home position mark while the microfluidic device is rotating, wherein the at least one chamber and the home position mark are arranged at a same distance from a center of the platform, and the home position mark has a light transmittance which is different from a light transmittance of the at least one chamber; detecting the light passing through the microfluidic device; and comparing an intensity of the detected light with a reference threshold to detect a reference angle of the microfluidic device, the method including.

### BRIEF DESCRIPTION OF THE DRAWINGS

The above and other aspects of the exemplary embodiments will be more apparent from the following detailed description taken in conjunction with the accompanying drawings in which:

FIG. 1 is a perspective view of a microfluidic device according to an embodiment;

FIG. 2 is a perspective view of a microfluidic system according to an embodiment;

FIG. 3 is a graph illustrating a method of detecting a reference angle of a microfluidic device according to an embodiment; and

FIG. 4 is a graph enlarging an area adjacent to a reference angle in the graph of FIG. 3.

### DETAILED DESCRIPTION

Exemplary embodiments now will be described more fully hereinafter with reference to the accompanying drawings. The inventive concept may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the disclosed embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

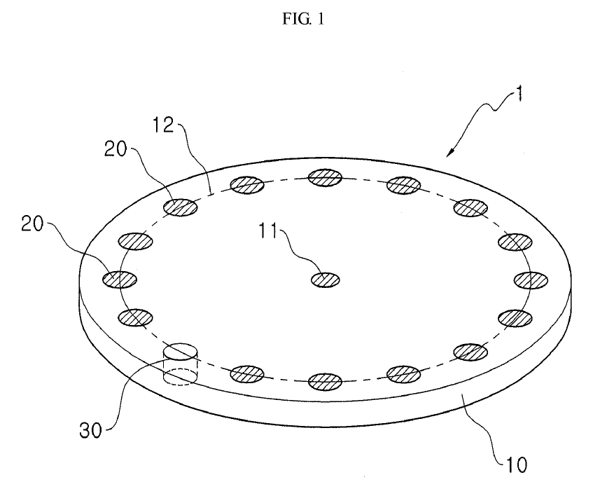

FIG. 1 is a perspective view of a microfluidic device according to an embodiment.

As shown in FIG. 1, the microfluidic device 1 may include a platform 10, a plurality of chambers 20 provided on the platform 10, and a home position mark 30 provided on the platform 10. The platform 10 may have disc shape with is rotatable with respect to a center of rotation 11, or may be have other shapes. Other microfluidic structures (not shown) may be arranged on the platform 10 to analyze a sample with a biochemical reaction of the sample. The configuration and arrangement of the microfluidic structures may be vary depending on the uses of the microfluidic device 1.

The plurality of chambers 20 are provided for observing the results of the biochemical reaction of a sample, which is performed in the microfluidic structures arranged on the platform 10. Each chamber 20 may be formed to accommodate a fluidic sample. The shape and the number of the chambers 20 illustrated in FIG. 1 are arbitrary, and may be different depending on the uses of the microfluidic device 1. The plurality of chambers 20 may be arranged at a same distance from the center of rotation 11 of the platform 10, i.e., arranged along an arc of a circular path 12 which is centered with respect to the center of rotation 11 of the platform 10. The length of arc of the circular path 12 may vary depending on the number and the arrangement of the chambers 20.

The home position mark 30 may be formed on the platform 10 and arranged on the circular path 12, along which the chambers 20 are arranged and move by the rotation of the platform 10. In an embodiment, the plurality of chambers 20 and the home position mark 30 may be arranged at constant intervals on the circular path 12. There may also be a plurality of home position marks 30.

The home position mark 30 is provided a position corresponding to an origin, which is utilized to determine the position of each chamber 20 in the microfluidic device 10. Herein, in case of radiating light on the microfluidic device 1 while rotating the microfluidic device 1, a reference angle is defined as the rotation angle at which the home position mark 30 is located between a light emitting part and a light receiving part, as described below.

The home position mark 30 may be formed with a material or a structure, which has a light transmittance different from that of the chambers 20. In one embodiment, the mark 30 may be made with a material or a structure having a higher light transmittance than that of the chambers 20. Because the transmittance of the chambers 20 may be variable in accordance with the kind and/or the presence of a sample stored in the chambers 20, the home position mark 30 may be formed with a material or a structure, which has a higher light transmittance than a maximum light transmittance of the chambers 20, depending on the types of samples that are able to be retained in the chambers 20.

For example, the home position mark 30 may be a hole or a plurality of holes passing through the platform 10. Because the chamber 20 may have at least one of its surfaces covered with a polymer or glass, the hole penetrating the platform 10 may have a higher light transmittance than that of the chambers 20 due to less loss of light caused by absorption or reflection. FIG. 1 shows that the home position mark 30 is formed as a round-shaped hole, but the mark 30 may be hole having another shape such as an oval or polygonal. Alternatively, the home position mark 30 may be a groove formed on the platform 10.

In another embodiment, the home position mark 30 may be formed with a material or a structure having a lower light transmittance than that of the chambers 20. For example, the home position mark 30 may include a light reflection area or a light absorption area. The light reflection area may include such a material or a structure, which reflects an incident ray of light, as a mirror. The absorption area may include a material or a structure like a black material, which absorbs light. Herein, the light reflection or absorption area corresponds to an area having a relatively lower light transmittance than that of the chambers 20, because the reflection or absorption area reflects or absorbs all or at least some ray of light incident upon the area.

In another embodiment, the home position mark 30 may include a combination of at least one of area, which has a higher light transmittance than that of the chambers 20, and at least one of area, which has a lower light transmittance than that of the chambers 20. For example, the home position mark 30 may have a light reflection area, and a certain area within the reflection area may include a hole passing through the platform 30.

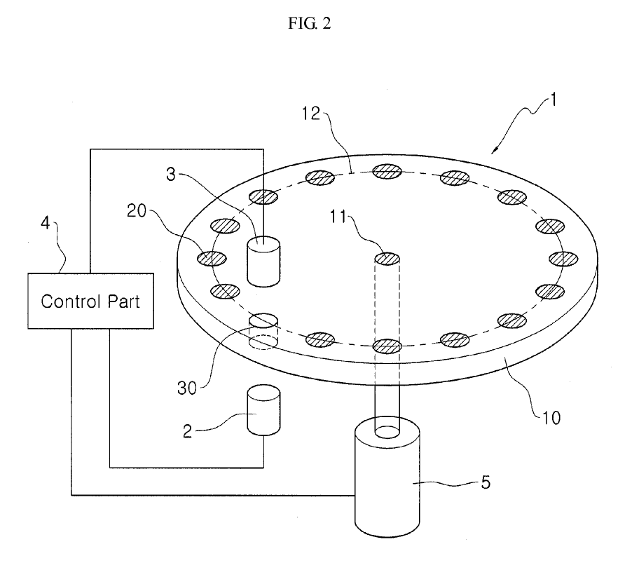

FIG. 2 is a perspective view illustrating a microfluidic system according an embodiment.

As shown in FIG. 2, the system may include the microfluidic device 1, which is explained above, a light emitting part 2 and a light receiving part 3, between which the microfluidic device 1 is located, and an operating part 5 rotating the microfluidic device 1. The light emitting part 2 may be a device radiating light with a particular wavelength. For example, the light emitting part 2 may include a light-emitting diode (LED), a laser diode (LD), or other appropriate light-emitting element(s). The wavelength of light radiated by the emitting part 2 may be determined based on the use of the microfluidic device 1 and the type of sample.

The microfluidic device 1 may be arranged between the light emitting part 2 and the light receiving part 3, and may be rotated by the operating part 5. While the microfluidic device 1 is rotating, the light emitting part 2 may radiate light upon the microfluidic device 1. The structure of the microfluidic device 1 is the same as that of the embodiment explained above in reference to FIG. 1.

The operating part 5 is connected to the center of rotation 11 of the microfluidic device 1, and may rotate the microfluidic device 1. For example, the operating part 5 may include a motor, such as a spindle motor, to rotate the microfluidic device 1 mounted thereon. The operating part 5 may rotate the microfluidic device 1 so that the chambers 20 and the home position mark 30 of the microfluidic device 1 pass through a path of light between the light emitting part 2 and the light receiving part 3. In order for light to be radiated upon the home position mark 30 regardless of the initial position of the mark 30, the operating part 5 may rotate the microfluidic device 1 one rotation during the process of detecting a reference angle.

The light receiving part 3 detects light passing through the microfluidic device 1. For example, the light receiving part 3 may include a photodiode or other appropriate light-receiving elements. The intensity of light incident upon the light receiving part 3 is proportional to the light transmittance of each area of the microfluidic device 1. For example, if the home position mark 30 has a higher light transmittance than the chambers 20, the light passing through the home position mark 30 may be greater in intensity than the light penetrating the chambers 20. Alternatively, if the mark 30 has a lower light transmittance than the chambers 20, the light passing through the chambers 20 may be greater in intensity than the light passing through the home position mark 30.

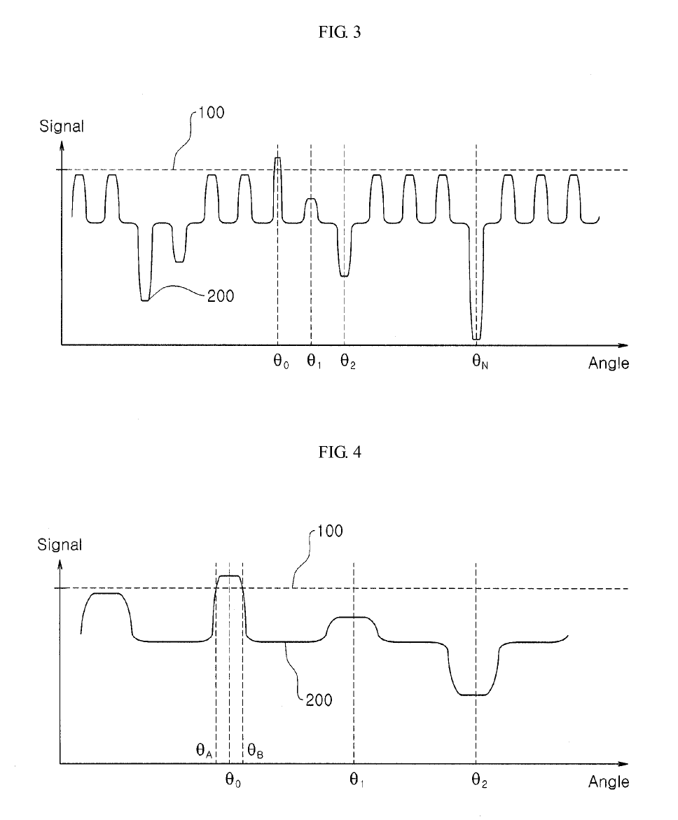

A system according to one embodiment may include a control part 4, which detects a reference angle, i.e., a rotation angle at which the mark 30 lies between the light emitting part 2 and the light receiving part 3, by comparing the intensity of light incident upon the light receiving part 3 with a reference value. The reference value may be set as a value higher than the maximum intensity of light penetrating the chambers 20, or as a value lower than the minimum intensity of light passing through the chambers 20, in consideration of samples retainable in the chambers 20. Further, if the home position mark 30 is formed with a combination of areas which have high light transmittances, and areas which have low transmittances, the reference angle may be determined with a plurality of reference values different from each other. The process of detecting the reference angle in the control part 4 will be explained below in detail in reference to FIGS. 3 and 4.

Using the light emitting part 2 and the light receiving part 4, the microfluidic system, as stated above, may detect the light absorbances (or the light transmittances) of the chambers 20, and of the home position mark 30 that is arranged along the circular arc of the chambers 20. Accordingly, an additional light source and a light detector are not required to detect a home position, and, an error of physical arrangement of light detectors, or a time difference due to the difference between reaction speeds, may be avoided. Thus, an error of measurement may be reduced and/or eliminated. In addition, because the system does not utilize an additional light source or light detector, the structure may be simplified and costs may be reduced.

FIG. 3 is a graph illustrating the process of detecting a reference angle of the microfluidic device according to an embodiment. FIG. 3 represents the output of the light receiving part 3 with respect to the rotation angle of the microfluidic device 1, during one rotation of the microfluidic device 1 in which the home position mark 30 includes a hole penetrating the platform 10.

The method for detecting the reference angle of the microfluidic device according to the embodiment is explained below with reference to FIGS. 2 and 3. The two curves depicted in FIG. 3 indicate the signals corresponding to a reference value 100 and the output 200 of the light receiving part 3, respectively. The output 200 of the light receiving part 3 is proportional to the intensity of light incident upon the light receiving part 3, which is proportional to the light transmittance of an area located between the light emitting part 2 and the light receiving part 3 depending on the rotation angle of the microfluidic device 1.

The reference value 100 is larger than the maximum value of the intensity of light passing through the chambers 20, so the reference angle of the microfluidic device 1 may be detected by detecting the angle θ₀ at which the output 200 of the light receiving part 3 increases over the reference value 100. In other words, when the microfluidic device 1 rotates by the angle θ₀ from its initial position, the home position mark 30 lies between the light emitting part 2 and the light receiving part 3, and the position of the microfluidic device 1 at this moment is the home position.

In an embodiment, the control part 4 may store the relative angles between the plurality of chambers 20 and the home position mark 30, which are previously measured from the mechanical shape of the microfluidic device 1. If the reference angle θ₀ of the microfluidic device 1 is detected, the control part 4 may calculate the rotation angle corresponding to the position of each chamber 20, using the pre-stored relative angles between the home position mark 30 and each of the chambers 20. In FIG. 3, the angle θ₀ indicates the reference angle, the angles θ₁, θ₂, . . . , θ_{N} are calculated from the reference angle θ₀ and represent the rotation angles corresponding to the positions of the chambers 20, respectively.

The control part 4 may control the operating part 5 in accordance with the rotation angle corresponding to the position of each chamber 20, and may thus rotate the microfluidic device 1 to align one or more of the chambers 20 with the path of light between the light emitting part 2 and the light receiving part 3. For example, when the home position of the microfluidic device 1 is determined, the control part 4 may rotate the microfluidic device 1 successively by the relative angle between the adjacent chambers 20 along one direction from the home position.

Because the curve of FIG. 3 is the result obtained from the use of a hole as the home position shaped mark 30, the output 200 of the light receiving part 3 increases beyond the reference value 100 at the reference angle θ₀. In another embodiment, in case of using the home position mark 30 which has a light transmittance smaller than that of the chambers 20, the reference angle may be detected from the phenomenon that the output 200 of the light receiving part 3 decreases below a certain reference value. In another embodiment, if the home position mark 30 is formed with a combination of areas having light transmittances higher that of the chambers 20 and areas having light transmittances lower that of the chambers 20, the reference angle may be detected by using a plurality of reference values.

FIG. 4 is a graph illustrating the process of detecting the reference angle of the microfluidic device according to another embodiment. FIG. 4 depicts the enlarged view of the area adjacent to the reference angle θ₀ in FIG. 3.

Referring to FIGS. 2 and 4, the reference angle θ₀ of the microfluidic device 1 may be calculated from Equation 1. That is, the reference angle θ₀ of the microfluidic device 1 is the mean value of θ_{A} and θ_{B}, where θ_{A} is an angle at which the output 200 of the receiving part 3 increases beyond the reference value 100 for the first time, and θ_{B} is an angle at which the output 200 decreases again below the reference value 100.

θ₀=(θ_{A}+θ_{B})/2 [Equation 1]

While the exemplary embodiments have been shown and described, it will be understood by those skilled in the art that various changes in form and details may be made thereto without departing from the spirit and scope of the inventive concept as defined by the appended claims.

In addition, many modifications can be made to adapt a particular situation or material to the teachings of this disclosure without departing from the essential scope thereof. Therefore, it is intended that the inventive concept not be limited to the particular exemplary embodiments disclosed as the best mode contemplated for carrying out this disclosure, but that this disclosure will include all embodiments falling within the scope of the appended claims.

What is claimed is:

1. A microfluidic device comprising:
a platform having a disc shape;
at least one chamber formed on the platform; and
a home position mark formed on the platform, wherein the at least one chamber and the home position mark are arranged at a same distance from a center of the platform, and
wherein the home position mark has a light transmittance which is different from a light transmittance of the at least one chamber.

2. The microfluidic device according to claim 1, wherein the at least one chamber and the home position mark are arranged at different positions along a circular path which is centered with respect to the center of the platform.

3. The microfluidic device according to claim 1, wherein the light transmittance of the home position mark is higher than the light transmittance of the at least one chamber.

4. The microfluidic device according to claim 3, wherein the home position mark comprises a hole passing through the platform.

5. The microfluidic device according to claim 1, wherein the light transmittance of the home position mark is lower than the light transmittance of the at least one chamber.

6. The microfluidic device according to claim 5, wherein the home position mark comprises a light reflection area.

7. The microfluidic device according to claim 5, wherein the home position mark comprises a light absorption area.

8. The microfluidic device according to claim 1, wherein the home position mark comprises a first area having a light transmittance which is higher than the light transmittance of the at least one chamber and a second area having a light transmittance which is lower than the light transmittance of the at least one chamber.

9. A microfluidic system comprising:
a light emitting part which emits light;
a light receiving part which receives the light emitted by the light emitting part;
a microfluidic device comprising a platform which has a disc shape and is interposed between the light emitting part and the light receiving part, at least one chamber formed on the platform, and a home position mark formed on the platform;
an operating part which rotates the microfluidic device; and
a control part which compares an intensity of light incident upon the light receiving part with a reference value to detect a reference angle of the microfluidic device,
wherein the at least one chamber and the home position mark are arranged at a same distance from a center of the platform, and
wherein the home position mark has a light transmittance which is different from a light transmittance of the at least one chamber.

10. The microfluidic system according to claim 9, wherein the at least one chamber and the home position mark are arranged at different positions along a circular path which is centered with respect to the center of the platform.

11. The microfluidic system according to claim 9, wherein the operating part rotates the microfluidic device so that the at least one chamber and the home position mark pass through a path of the light emitted from the light emitting part.

12. The microfluidic system according to claim 9, wherein the control part determines, based on the detected reference angle, a rotation angle of the microfluidic device corresponding to a position of the at least one chamber.

13. The microfluidic system according to claim 9, wherein the home position mark comprises a hole passing through the platform.

14. The microfluidic system according to claim 9, wherein the home position mark comprises a light reflection area or a light absorption area.

15. The microfluidic system according to claim 9, wherein the home position mark comprises a first area having a light transmittance which is higher than the light transmittance of the at least one chamber and a second area having a light transmittance which is lower than the light transmittance of the at least one chamber.

16. A method for detecting a reference angle of a microfluidic device which comprises a platform having a disc shape, at least one chamber formed on the platform, and a home position mark formed on the platform, the method comprising:
radiating light upon on the at least one chamber and the home position mark while the microfluidic device is rotating, wherein the at least one chamber and the home position mark are arranged at a same distance from a center of the platform, and the home position mark has a light transmittance which is different from a light transmittance of the at least one chamber;
detecting the light passing through the microfluidic device; and
comparing an intensity of the detected light with a reference threshold to detect a reference angle of the microfluidic device.

17. The method according to claim 16,
wherein the at least one chamber and the home position mark are arranged at different positions along a circular path which is centered with respect to the center of the platform, and
wherein the radiating light comprises radiating light upon the circular path.

18. The method according to claim 16, further comprising determining, based on the detected reference angle, a rotation angle of the microfluidic device corresponding to a position of the at least chamber.

19. The method according to claim 16, wherein the home position mark comprises a hole passing through the platform.

20. The method according to claim 16, wherein the home position mark comprises a light reflection area or a light absorption area.
